(19) United States
(12) Patent Application Publication
(10) Pub. No.: US 2010/0054567 A1
(43) Pub. Date: Mar. 4, 2010

(54) METHOD AND APPARATUS FOR INTERACTIVE CT RECONSTRUCTION

(75) Inventors: Lars Hillebrand, Erlangen (DE); Robert Lapp, Nurnberg (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: CT Imaging GmbH, Erlangen (DE)

(21) Appl. No.: 12/538,232

(22) Filed: Aug. 10, 2009

(30) Foreign Application Priority Data
Aug. 13, 2008 (DE) 10 2008 038 953.6
Feb. 5, 2009 (DE) 10 2009 007 680.8

(51) Int. Cl. G06K 9/00

(52) U.S. Cl. 382/131

(57) ABSTRACT

A method and an apparatus for interactive image reconstruction, in particular in computed tomography are disclosed. The method for interactive image reconstruction by calculating tomographic slice images from X-ray projection data is distinguished by the fact that only those grayscale images which the user wants visualized at a given time are calculated with the aid of a computer.

### CROSS-REFERENCES TO RELATED APPLICATIONS

This application claims the priorities of German Patent Applications, Serial No. 10 2008 038 953.6, filed Aug. 13, 2008, and 10 2009 007 680.8, filed Feb. 5, 2009, pursuant to 35 U.S.C. 119(a)-(d), the contents of which are incorporated herein by reference in its entirety as if fully set forth herein.

### BACKGROUND OF THE INVENTION

The present invention relates to a method and an apparatus for interactive image reconstruction, in particular in computed tomography

The following discussion of related art is provided to assist the reader in understanding the advantages of the invention, and is not to be construed as an admission that this related art is prior art to this invention.

To ensure clarity, it is necessary to establish the definition of several important terms and expressions that will be used throughout this disclosure.

The term “Hounsfield unit” (abbreviated HU) is a measure for X-ray attenuation by a certain material and is used in particular in computed tomography. The Hounsfield scale is defined such that the attenuation value of water is at 0 HU and that of air is at −1000 HU. These X-ray attenuation values specified in HU are also referred to as CT values.

The term “reconstruction” is understood to be the overall process which is used to calculate the attenuation values for the voxels of a volume or a voxel plane from the information contained in a data record. A so-called “Feldkamp reconstruction” is composed of preprocessing and the subsequent back projection.

The term “convolution kernel” (also known as a “reconstruction kernel”) is understood to be a function by means of which the values of a projection are combined by convolution. A convolution kernel is referred to as “sharp” or “steepening” if the combination with the projection image emphasizes small details and edges. It is referred to as a smooth convolution kernel if it blurs small details and noise by the convolution with the projection image.

The projections are processed during “preprocessing”. Depending on the application, this includes a number of individual steps: necessarily logarithmizing and weighting of the projection values and also the convolution with the convolution kernel.

The term “image” is understood to be the reconstructed display of the object, shown, for example, on a monitor. Conventionally, it is displayed in grayscale values. However, colored displays are in principle also conceivable.

The term “pixel” is the smallest element of an image and contains only a single grayscale or color value.

The human eye can only distinguish between approximately 80 grayscale values. The CT values in medicine normally lie between −1000 and 3000 HU. The value range to be displayed is thus significantly greater than the number of grayscale values that the eye can perceive. It is for this reason that it is always only part of the HU scale which is selected to be displayed and imaged in the grayscale value range; this is referred to as “windowing”.

The term “object space” refers to a three-dimensional space in which the object to be examined, e.g. a patient, is located. This space is preferably described by three orthogonal coordinate axes, which are referred to as x, y and z axes in the following text.

The term “voxel” is understood to be an element of the object space. A voxel can have any shape, preferably the shape of a die or cube. A voxel is assigned a value, preferably specified in HU, of the attenuation of the X-rays in the corresponding portion by the reconstruction.

The term “volume” is understood to be a three-dimensional grid in which a voxel is located in each grid point. This grid is preferably Cartesian, that is to say it orients itself along the three coordinate axes of the object space.

The term “voxel layer” is understood to be a two-dimensional grid which corresponds to a layer from a volume. It is for this reason that a voxel layer preferably orients itself along the coordinate axes of the object space.

The term “voxel plane” is understood to be a two-dimensional grid of voxels. This grid lies in a plane in the object space which can have any orientation.

A computed tomography scanner generates X-ray images of the object to be examined during a measurement with the aid of X-rays. An individual image of said type is referred to as a “projection”. A projection includes geometry parameters for describing the position of the X-ray source and the detector and how it is situated in space.

The term “data record” combines all information transmitted to the data processing apparatus by the computed tomography scanner during a measurement. This includes all recorded projections and their geometry parameters.

The human eye cannot distinguish individual images from about 25 images per second, that is to say approximately 40 ms per image, and instead perceives fluid motion. It is for this reason that in the following text calculation times of less than 100 milliseconds for calculating a voxel plane and the associated image should be considered to be “real-time capable”.

The term “GPU” (graphics processing unit, graphic card) is an electronic data processing unit which is designed specifically for calculations in the field of computer graphics.

The term “texture” is understood to be a memory region belonging to the GPU. The projections and results of the calculation are saved in textures.

The term “OpenGL” (Open Graphics Library) is a specification for a platform and programming language independent programming interface for developing software in the field of 3D computer graphics. A realization of the invention utilizes OpenGL for programming the GPU.

The term “shader program” is understood to be software executed on the GPU.

In principle, the workflow in computed tomography (CT) has remained unchanged in the past decades: the user selects the parameters for the scan and the reconstruction. The patient is scanned. Subsequently, a volume (3D grid) is reconstructed from the obtained data. This volume can comprise several hundred voxel layers. After the calculation, the user can select voxel layers to be observed. Then, grayscale images thereof are generated and displayed in accordance with the current settings for the windowing.

The reconstruction step requires a lot of time. In practice, these times range from a few minutes to a number of hours, depending on the utilized hardware and the size of the data record.

It would be desirable and advantageous to reduce the calculation time of the image reconstruction of CT images.

### SUMMARY OF THE INVENTION

According to one aspect of the present invention, a method for interactive image reconstruction by calculating tomographic slice images from X-ray projection data, in particular in cone beam computed tomography, includes the step of calculating only those grayscale images which a user wants visualized at a given time by a computer.

According to another aspect of the present invention, an apparatus for interactive image reconstruction by calculating tomographic slice images from X-ray projection data, in particular in cone beam computed tomography, includes a computer calculating only those grayscale images which a user wants visualized at a given time.

According to another aspect of the present invention, a computer program for interactive image reconstruction by calculating tomographic slice images from X-ray projection data, in particular in cone beam computed tomography, is configured to calculate only those grayscale images which a user wants visualized at a given time, when the computer program is executed on a computer.

The advantages and refinements explained in the following text in the context of the method analogously also apply to the system according to the invention, and vice versa.

Interactive, preferably GPU accelerated, CT image reconstruction is presented, in particular in cone beam CT. In the process, a novel approach for CT reconstruction in real-time is described which offers the user the possibility of interactively changing parameters for orienting the voxel plane and the position of the voxel plane during the analysis, that is to say while the user observes the grayscale images. To make this possible, a new voxel plane is required every time the user wants a new grayscale image. For this purpose, a back projection in a voxel plane is effected, in contrast to a volume reconstruction carried out before the analysis as is known from the prior art.

For improved understanding, it is already noted here that a voxel is reconstructed for every pixel in the subsequent image. In other words, a voxel plane in the object space is first of all defined for every image to be newly calculated. A grid of voxel positions is defined on this plane, a voxel being assigned to a pixel in the subsequent image.

Using this approach, the user is free to change parameters which cannot be changed in a conventional reconstruction. Thus, the position of the voxel plane and the voxel size can be set to arbitrary values, or other projections can be selected for the reconstruction, for example in the case of a cardiac reconstruction.

In other words, a basic idea of the invention is to integrate the reconstruction into the user's analysis of the grayscale images. This removes the waiting time for the reconstruction. This is possible because the user always only views a few images simultaneously, usually one to four, and not several hundred. Hence, it is also only necessary to calculate the images which the user wants to see at a given time.

In one embodiment of the invention, the reconstruction is realized using a GPU with OpenGL. In other words, an additional acceleration is achieved by the fact that the reconstruction is realized on graphics hardware. Additionally, the manufacturer-independent OpenGL technology is advantageously used. It is also possible to use other techniques as an alternative to OpenGL, such as DirectX or manufacturer-specific codes, for example CUDA, CTM, OpenCL, Brook.

In the following text, the invention will be described in more detail.

Provision is made for a novel method for image reconstruction by calculating tomographic slice images from X-ray projection data. It is distinguished by the fact that instead of reconstructing a volume from the raw data of the projection, in each case only a voxel plane, that is to say a 2D grid, is calculated and a grayscale image corresponding to this voxel plane is displayed. Here, a voxel plane precisely corresponds to a grayscale image. This makes is possible to attain reconstruction times which afford the possibility of a “live reconstruction”, i.e. a reconstruction in real-time. For each additional grayscale image a new reconstruction of a voxel plane is necessary.

“Images” or “grayscale images” refer to the images of the scanned object to be calculated. These can also comprise colored images. However, the use of grayscale images is conventional.

The reconstruction (generation of grayscale images) is interactive. It is always only an individual voxel plane that is reconstructed for a grayscale image. If, for example, three grayscale images are intended to be displayed simultaneously, the reconstruction of three voxel planes is necessary.

Since it is always only one voxel plane that is reconstructed, the required computational complexity compared to a conventional reconstruction of a volume is small (a factor of 100 to 1000). Together with the high computational performance of current GPUs, this results in reconstruction times of significantly less than 1 second (approximately 10-100 ms, depending on the data record). This makes it possible to generate a new grayscale image at any time. This affords the possibility of a completely free selection of a few parameters, such as:
the voxel size (implementation of a zoom-function),
the position of the voxel plane in the object space (implementation of a scroll function in the X, Y and Z directions to any position or in arbitrarily small steps),
the interactive selection of the projections used for the reconstruction (implementation of dynamic scans, cardiac CT),
the inclination (the voxel plane can be tipped arbitrarily in the object space).

Additionally, the following features can be realized:
the dynamic change of the reconstruction filter (renewed partial preprocessing of the projection images),
the integration of MAR (metal artifact reduction), such a reconstruction only requiring small additional expenditure compared to the prior art (volume reconstruction), since only one voxel plane is present,
the simultaneous use of a number of views, i.e. a number of voxel planes, (preferably up to four views, three views orienting themselves along the three coordinate axes and a fourth view showing an arbitrary slice through the volume),
the use of a number of graphics cards and the division of the raw data between the GPUs; this results in a further reduction in the reconstruction time.

The following text explains the functioning of the method according to the invention.

All projection images are stored in textures on the GPU. Here, a texture is understood to be a certain memory region in the local memory of the GPU. Additionally, a results texture is created, in which the result of the reconstruction (the subsequent voxel plane) is stored.

A new grayscale image is generated in a number of steps:

Step 1: Loading the data record and preprocessing. The preprocessing includes procedures such as the interpolation of measurement data in the case of defective detector elements, weighting, convoluting. Subsequently, the projection images are transferred to the textures.

Step 2: Back projection (calculating the voxel plane) in accordance with the object view desired by the user, including the sub-steps:

Step 2.1: Calculating the required transformations (from “pixel” to “voxel”) in the object space corresponding to the currently desired voxel size, position and inclination of the voxel plane.

Step 2.2: Activating the shader program required for the back projection and configuring the non-programmable parts of the GPU (texture units, raster operations (ROPs)).

Step 2.3: Configuring the GPU to write the results texture.

Step 2.4: Successive processing of the desired projections. This is effected in small packets of preferably three to eight projections, depending on the performance parameters of the respective GPU, including the sub-steps:

Step 2.4.1: Assigning the projection textures to texture units.

Step 2.4.2: Transferring the geometry parameters of the projections to parameters of the shader program on the GPU.

Step 2.4.3: Drawing a quadrilateral so that a fragment is generated in the graphics pipeline for every voxel in the voxel plane (value in the results texture) and hence the calculation of the back projection values for the current projection packet is effected in fragment processing.

The steps 1 (preprocessing, i.e. processing the projection images) and 2 (back projection) can be combined by the term “reconstruction”.

Step 3: Norming the results of the back projection to the HU scale, including the sub-steps:

Step 3.1: Activating the shader program required for the norming and configuring the non-programmable parts of the GPU (raster operations (ROPs)) according to the required scaling parameters.

Step 3.2: Drawing a quadrilateral so that a fragment is generated for each voxel and the processing is carried out.

Step 4: Generating a grayscale image from the values in the results texture (“windowing”), including the sub-steps:

Step 4.1: Activating the shader program required for generating the grayscale images. Transferring the currently selected parameter for the windowing region to the parameter of the shader program on the GPU.

Step 4.2: Assigning the results texture to a texture unit for read access.

Step 4.3: Configuring the GPU for writing the display region (preferably using double-buffering).

Step 4.4: Drawing a quadrilateral so that a grayscale value corresponding to the HU value and the windowing parameters read out from the results texture is calculated and stored for every pixel to be generated. The windowing parameters are fixed in advance to select a certain working range of HU values.

Depending on the action of the user, it is not always necessary to run through all processing steps. Processing from step 1 is only necessary if a new data record is selected, i.e. during the generation of the first grayscale image. Processing from step 2 is required if the user selects new values for the position, inclination, voxel size or projections to be used. Processing from Step 4 is required if the user selects new values for the windowing limits. The processing is effected immediately after the user has selected the parameters.

The following should be noted with respect to the preprocessing which is part of step 1: The reconstruction is composed firstly of a preprocessing of the projection images including convolution, and secondly of a subsequent back projection. In one embodiment of the invention, the entire preprocessing is carried out only once when a data record is loading. This is completely effected by software on the CPU, i.e. it is not GPU accelerated.

In one embodiment of the invention, provision is made for the preprocessing also to be realized in part or completely on the GPU. The advantage of this is that the convolution kernel (or reconstruction kernel) can likewise be changed interactively. Compared to the back projection, the computational complexity of the actual convolution is low. However, a different convolution requires a new back projection. It is for this reason that it was previously much too complicated to use methods known from the prior art to try a number of convolution kernels. However, using the novel method, the back projection is so fast that quickly recalculating it is no longer a problem.

The convolution kernel has a great influence on the subsequent image. A very “sharp” convolution kernel offers a high spatial resolution, but also generates strong noise in the grayscale image. By contrast, a “smooth” kernel offers a very low-noise grayscale image but also reduces the spatial resolution, i.e. small details are blurred and can possibly no longer be recognized. Therefore, the user previously had to put much thought into which kernel was to be used before the reconstruction started. As a worst case scenario, a wrong kernel can make diagnosis impossible and require a new reconstruction. If the convolution is likewise realized on the GPU, interactively changing the convolution kernel in any case no longer constitutes a problem.

Additionally, there is a connection in CT between the image noise and the X-ray dose. The higher the dose is, the lower the noise is. To be more precise, a fourfold increase in the X-ray dose has to be applied to halve the noise. It is for this reason that the application of the method according to the invention offers a possibility for dose reduction if there are no problems with observing the image using different convolution kernels, e.g. once with a high resolution and noise, for example, and subsequently when it has been smoothed a lot.

In the following text, the conventional reconstruction method is compared to the method according to the invention.

All previous reconstruction methods provide for the following procedure (prior art):

Step 1: Carrying out the scan and hence acquiring the projection images (raw data).

Step 2: Selecting the reconstruction parameters:
a) volume size and position
b) voxel size and hence determining the detail resolution of the volume to be reconstructed
c) reconstruction filter (also referred to as reconstruction kernel or convolution kernel)
d) in the case of cardiac CT or a dynamic scan: selecting the projections to be used

Step 3: Reconstructing the volume, including the sub-steps:

Step 3.1: Preprocessing the projection images, e.g. logarithmizing, weighting. This can already be effected during the scan.

Step 3.2: Convoluting the projection images with the reconstruction filter. This results in a projection image with suppressed low frequencies.

Step 3.3: Back projection. Here, a 3D grid is calculated (volume), with an attenuation value being calculated for every point (voxel) in this grid. The 3D grid is (almost) always aligned with the coordinate axes of the object because in this way some intermediate results can be used for a number of voxels. These days, typical sizes of such volumes are 512³ or 1024³ voxels. An average PC (CPU) requires up to an hour for such a reconstruction, the back projection accounting for most of this.

Step 3.4: Scaling, i.e. converting, the X-ray attenuation values into HU values. For the subsequent evaluation of the volume it is necessary to fix a “window” on the HU scale and assign grayscale values to the window values.

Step 3.5: Saving the calculated volume, generally onto a hard disk drive.

Step 4: Evaluating the volume by the user. The user usually sees one to four images, which correspond to views from different directions. Usually, the position of these images corresponds to the individual voxel layers in the volume, which is why the user can only jump between different voxel layers but cannot view “intermediary layers”, at best by interpolation between adjacent voxel layers. Inter alia, the following situations can occur:
i) The user would like to view a small detail more closely: It is possible to “zoom in” on the detail, but soon only a very rough or pixelated image is obtained because for every pixel in the image viewed by the user only the respectively closest lying voxel is selected, or possibly there is an interpolation between pixels. However, this does not provide new details, even if the resolution of the detectors or the projections would permit this, because the resolution is also limited by the voxel spacing in the volume. In this case, the user can only mark the region of interest and start a new reconstruction for said region, i.e. start a new back projection with smaller voxels.
ii) An oblique cut through the volume is intended to be displayed: The slice image requires many values to be interpolated from the precalculated voxels.
iii) During the evaluation of the volume the user discovers that the reconstruction kernel was not suitably selected: This leads to a blurring of small details in the case of a too “smooth” kernel, and in the case of a very steepening, “edge emphasizing” kernel there is much noise in the image. In an extreme case, the volume is useless and a new reconstruction with more suitable parameters must be started and this requires a new waiting time.

In contrast to the just-described prior art, the following is a preferred procedure of the method according to the invention:

Step 1: Carrying out the scan and hence acquiring the projection images (raw data).

Step 2: Preprocessing the projection images, e.g. logarithmizing, weighting. This can already be effected during the scan.

Step 3: Convoluting the projection images.

Step 4: The user observes the grayscale images corresponding to the voxel planes. Since the user only sees one to four grayscale images, it is only these which are calculated rather than a complete volume. In the process, an associated voxel is calculated for every pixel in the grayscale image. For example, if the images on the monitor have a size of 512² pixels, then only 512² voxels have to be calculated. This greatly reduces the duration of the back projection, particularly compared to a volume, by a three or four digit factor depending on the volume. Since the back projection is additionally effected on a GPU, the calculation time is again reduced considerably compared to a normal CPU-based reconstruction, and reconstruction times of a few milliseconds are attained. In order to calculate precisely one voxel for each pixel, a plane (voxel plane) is defined in the object space. The data point, that is to say the tip of the position vector for illustrating a plane in the space, is assigned to the center of the grayscale image to be calculated. A grid with just as many grid points (voxels) as are required for the image, i.e. 512² in this case, is then placed onto this plane. To this end, a transformation from the image plane to the voxel plane is defined and it combines a number of individual transformations:
a) scaling the voxel size and grid spacing in the plane
b) rotating the plane about the data point
c) translating the data point of the voxel plane.

The exact position in the object space is determined for each of these voxels and a back projection is carried out. Subsequently the results are scaled to HU values.

As a result of every user action which influences the position of the voxel plane, the voxels in the plane are newly reconstructed and a new grayscale image is displayed. This occurs without a noticeable time delay for the user because a calculation time of only a few milliseconds can barely be noticed.

In the above-described situations something else happens now:
i) The user would like to view a small detail more closely: The location of interest is centered in the grayscale image, as a result of which the data point of the voxel plane is, in the software, set precisely to this position (new translation in the transformation). Subsequently, a zoom factor can arbitrarily change the voxel size (new scaling in the transformation), which leads to a tighter voxel grid on the plane. The user more or less immediately sees a new grayscale image which is based on smaller voxels. The degree of detail is no longer limited by a reconstructed volume in the background, but only by the resolution of the projection images. Furthermore there are no waiting times for the user.
ii) An oblique cut through the volume is intended to be displayed: The user can arbitrarily rotate (new rotations in the transformation) the voxel plane about the position vector (image center). The new image is no longer based on interpolated values but a new, separate value is reconstructed for every pixel and voxel.
iii) During the evaluation of the volume the user discovers that the reconstruction kernel was not suitably selected: The user select a new filter kernel, subsequently a short calculation time of a few seconds is required to convolute the projection images with the new kernel. The user now obtains images with the new filter settings.

Thus, the main difference to the solutions previously known from the prior art lies in the fact that the reconstruction is effected interactively while the user looks at the images, and not beforehand. This reduces waiting times for the user and moreover affords the possibility of generating any arbitrary view.

In the following text, further advantages of the method according to the invention are specified and new possibilities for the user are highlighted.

There are significantly reduced waiting times for the user before a data record can be looked at. Waiting times only result from the preprocessing of the projections.

The user is no longer bound to a predetermined 3D volume, but can completely freely select the region of interest, including an arbitrary incline of the view.

Until now, if the user wanted to look at a small portion in more detail, a new reconstruction had to be effected every time and a renewed waiting time had to be accepted. Using the new method, a simple zoom to the region suffices to change the voxel size, which can be effected interactively and with only a short time delay (a few milliseconds).

The projections utilized for the back projection can be selected freely. This is firstly important for dynamic scans, in which a number of scans are effected successively without delay in order to, for example, detect the entire flow duration of the contrast agent in the case where contrast agent is dispensed. In order to obtain a good result, only those projections which were recorded as the contrast agent was in the region of interest should be used for the reconstruction. If the contrast agent was only acquired in a few projections, disruptive artifacts can be seen in the subsequent grayscale image. However, the selection of suitable projections is difficult and can require multiple reconstructions; this requires the user to wait for a long time. Using the new method, the selection of projections can be effected interactively, and the user immediately obtains a new image.

Secondly, this is important in the case of cardiac CT, in which those projections have to be selected where the heart was recorded during the same phase in order to reduce motion artifacts as far as possible. Until now, the result had to be evaluated after a reconstruction and if too strong motion artifacts made diagnosis impossible a new selection had to be made and a new reconstruction had to be carried out, which again meant waiting times for the user. Using the new method, the selection of projections can be effected interactively, and the user immediately obtains a new image.

Furthermore, from a technical point of view, it is advantageous that only the raw data acquired by the CT has to be saved and archived, and no longer the reconstructed volumes; this saves storage space. This is particularly important in flat panel detectors with a very high resolution, which can be used in particular in cone beam CT and will be available in the near future, because very large volumes have to be reconstructed when using such detectors in order to also utilize the degree of detail available, e.g. 4096³ voxel. Such large volumes can only be handled and archived with difficulties. This complexity is completely dispensed with when using the new method.

In addition to the applications already described above, it is also possible to use the present invention in dynamic scans. Here the respectively last 360° could also be reconstructed live using the novel method in order to enable a better monitoring of the patient during the scan.

In one embodiment of the invention, only the reconstruction of a complete circular scan is realized, i.e. a scan in which the projections were recorded over an angular range of at least 360°. In a further embodiment of the invention, part circular scans (180°+cone angle) are supported with a corresponding weighting of the projections (the so-called Parker weighting). The advantage of this additional embodiment lies in a higher temporal resolution in the case of dynamic scans or cardiac CT.

The invention is not limited to cone beam CT. In principle, it can also be applied to different types of CT, such as a clinical CT with an arced detector (in contrast to a flat panel detector). Such arced detectors are narrower than flat panel detectors and therefore also only acquire a narrower region of the patient. The above-described reconstruction method assumes that the detector moves around the patient along a circular orbit. This is also possible in clinical CT and is used, for example, in the case of cardiac CT, in which only the heart is intended to be detected. If the entire upper body or even the entire patient is intended to be detected, spiral CT is effected. Here, the detector rotates around the patient on a circular orbit during the entire scan, and the patient, together with the couch, is slowly fed through the CT scanner at a constant speed so that the detector moves on a spiral path (more precisely: a helix) relative to the patient. Reconstruction is much more complex in the case of spiral CT than in cone beam CT. However, the increased computational complexity could be compensated for by using a number of GPUs or a faster GPU.

The apparatus according to the invention is designed to carry out the described method for interactive image reconstruction. The apparatus is preferably a data processing unit, designed to carry out all steps in accordance with the method described herein, which steps are related to the processing of data. The data processing unit preferably has a number of functional modules, with each functional module being designed to carry out a certain function or a number of certain functions in accordance with the described method. The functional modules can be hardware modules or software modules. In other words, the invention, to the extent that it relates to the data processing unit, can either be realized in the form of computer hardware or in the form of computer software or as a combination of hardware and software. To the extent that the invention is realized in the form of software, that is to say as a computer program product, all described functions are implemented by computer program commands when the computer program is executed on a computer with a processor. Here, the computer program commands are realized in a known fashion in any programming language, and can be provided to the computer in any form, for example in the form of data packets which are transferred over a computer network or in the form of a computer program product stored on a disk, a CD-ROM or another data storage medium.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic illustration of a voxel plane in the object space,

FIG. 2 shows a screen shot of a software application for executing the method according to the invention, and

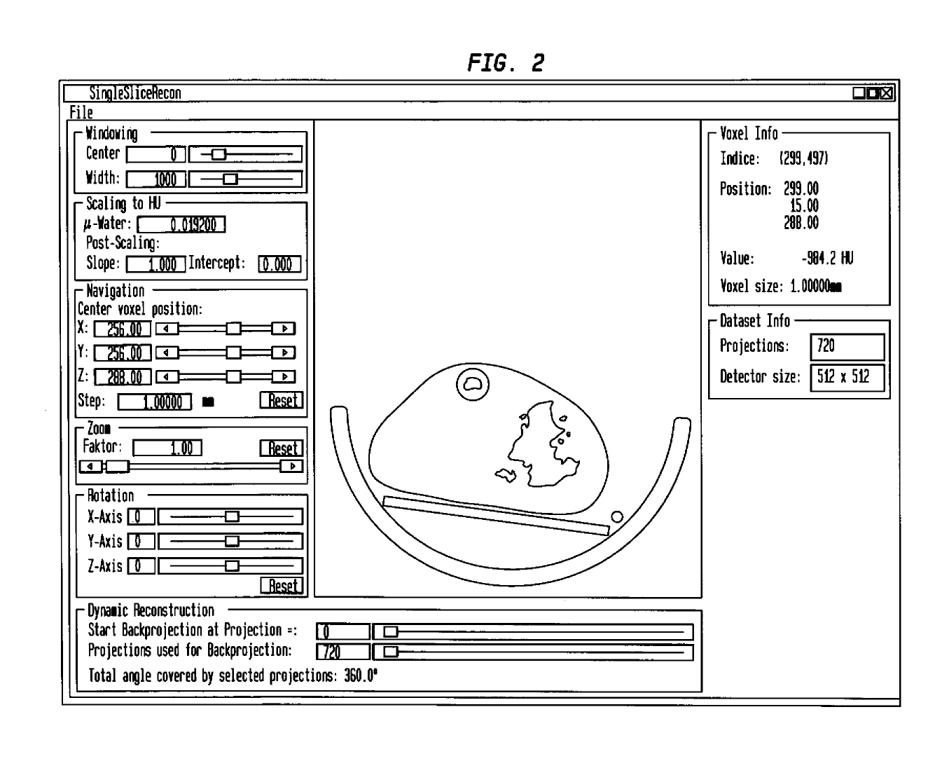

FIG. 3 shows a schematic illustration of the calculation of a voxel plane as illustrated in FIG. 2.

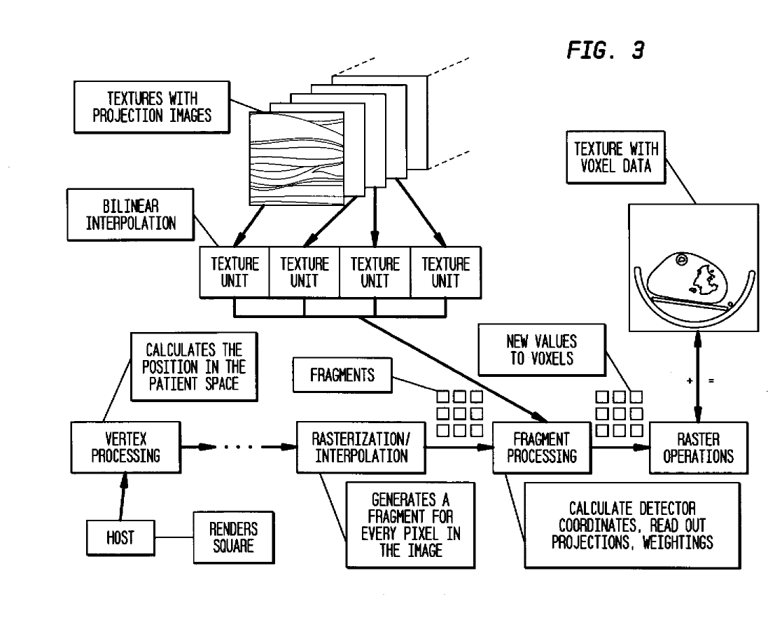

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

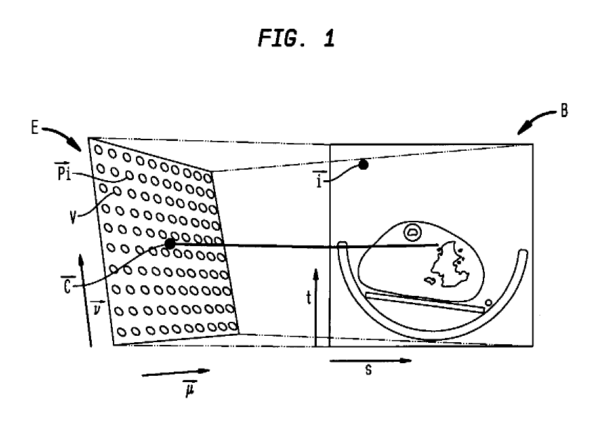

Turning now to the drawing, and in particular to FIG. 1, there is shown a schematic illustration of a voxel plane E in the object space. The voxel plane E, which is located in an arbitrary position in the object space, is determined by the position c of its center, the number of voxels V in the u and v directions and the size of the voxels. Each voxel V corresponds to a pixel i in the grayscale image to be calculated so that the size of the voxel plane E depends on the image size. In the example, the grayscale image B has a fixed size of 512×512 pixels. With the aid of a set of transformations, the pixel indices \vec{i}=(s,t) are imaged on the voxel coordinates, \vec{p}ᵢ=(x,y,z). The rotation of the voxel plane E about its center \vec{c} in accordance with the three axes also occurs in this step with the aid of a further transformation. All transformations are combined in a single transformation matrix \vec{M}.

All projection images are stored in textures in the memory of the GPU. Additionally, a further texture is generated to save the results of the reconstruction, that is to say the voxel plane. All values are stored as floating point numbers with 32 bit accuracy.

In order to generate a new grayscale image, a new transformation matrix M is firstly calculated and saved on the GPU. Subsequently, the projections are successively back projected. The required projections are assigned to texture units so that they can be read out, and the geometry parameters of the textures are transferred to the GPU. After this configuration, a quadrilateral which fills the entire voxel plane is drawn to update the voxels. The coordinates of the voxels in the corners of the voxel plane are calculated in a vertex shader and are passed on to the rasterization unit of the graphics card which interpolates the position of each voxel in the object space from this and passes it on to the fragment processing unit.

The fragment processing unit carries out the back projection for the current projections on the individual voxels and, as a result, supplies the value of the current projections to the voxels. These values have to be added to the values already placed in the voxel plane. This is performed by the last stage of the graphics pipeline, the ROPs (raster operations).

Once all projections are processed, the values of the voxels are scaled into CT attenuation values (Hounsfield units, HU). Subsequently a new grayscale image is calculated in accordance with the current window settings.

The reconstruction according to the invention is carried out with the aid of a computer program, the functioning of which is illustrated schematically in image 3. The data record illustrated there contains 720 projections with a detector resolution of 512² elements.

A dual core PC with 4 GB RAM and a GeForce 8800GTX GPU is used in the exemplary embodiment, as a result of which back projections can be calculated up to 50 times faster than with a single CPU based software. This makes it possible to achieve reconstruction times between 30 and 100 milliseconds. In a typical example, an individual reconstruction for example takes 37 milliseconds.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for interactive image reconstruction by calculating tomographic slice images from X-ray projection data, in particular in cone beam computed tomography, said method comprising the step of calculating only those grayscale images which a user wants visualized at a given time by a computer.

2. The method of claim 1, wherein, every time a grayscale image is desired by the user, a reconstruction of an individual voxel plane including a back projection of this voxel plane is carried out and a voxel is reconstructed for every pixel in the subsequent grayscale image.

3. The method of claim 2, wherein only one voxel plane is respectively calculated from the raw data of the X-ray projection in order to provide a grayscale image, and a grayscale image corresponding to this voxel plane is displayed.

4. The method of claim 1, wherein at least one of the following parameters is changeable by the user whilst observing the image: parameter for orienting the voxel plane, parameter for the position of the voxel plane, voxel size.

5. The method of claim 1, wherein at least one of the following parameters is changeable by the user whilst observing the image: parameter for inclining the voxel plane, parameter for the position of the voxel plane, voxel size.

6. The method of claim 1, further comprising the step of dynamically changing a reconstruction filter.

7. The method of claim 1, wherein the reconstruction is carried out by at least one graphics hardware component operating independently of the main processor of the computer.

8. Apparatus for interactive image reconstruction by calculating tomographic slice images from X-ray projection data, in particular in cone beam computed tomography, said apparatus comprising a computer calculating only those grayscale images which a user wants visualized at a given time.

9. Computer program for interactive image reconstruction by calculating tomographic slice images from X-ray projection data, in particular in cone beam computed tomography, said computer program being configured to calculate only those grayscale images which a user wants visualized at a given time, when the computer program is executed on a computer.
